(19) United States
(12) Patent Application Publication
(10) Pub. No.: US 2021/0090373 A1
(43) Pub. Date: Mar. 25, 2021

(54) BANKNOTE JAM TROUBLESHOOTING METHOD AND BILL RECYCLING TERMINAL

(71) Applicant: SHANDONG NEW BEIYANG INFORMATION TECHNOLOGY CO., LTD., Shandong (CN)

(72) Inventors: Zhuanlong YU, Shandong (CN); Ning FENG, Shandong (CN); Maolin LIU, Shandong (CN); Chuntao WANG, Shandong (CN); Jiabo XU, Shandong (CN)

(21) Appl. No.: 16/976,402

(22) PCT Filed: Mar. 7, 2019
(86) PCT No.: PCT/CN2019/077327

§ 371 Date: Aug. 27, 2020

(30) Foreign Application Priority Data
Mar. 13, 2018 (CN) 201810211712.6

(51) Int. Cl. G07D 11/237; G07D 11/25

(52) U.S. Cl. CPC G07D 11/237; G07D 11/50; G07D 11/25

(57) ABSTRACT

Disclosed are a banknote jam troubleshooting method and a bill recycling terminal. The banknote jam troubleshooting method includes, determining the troubleshooting path and the discharge device in case of banknote jam in the conveying passage; determining the multiple conveying sub-channels on the troubleshooting path; orderly discharging the banknotes in the multiple conveying sub-channels on the troubleshooting path from the sub-channel nearest to the discharge device to the sub-channel furthest; where the discharge device is any one among the input device, the output device, the temporary storage device, the recycling box or the recovering box, and the troubleshooting path is a path in the conveying passage for connecting the position of banknote jam to the discharge device.

This disclosure claims the priority of Chinese patent application No. 201810211712.6, which is filed with the State Intellectual Property Office of the People's Republic of China on Mar. 13, 2018 and the entirety of which is incorporated herein by reference.

### TECHNICAL FIELD

This disclosure relates to the field of banknote processing technology, such as a banknote jam troubleshooting method and a bill recycling terminal.

### BACKGROUND

The bill recycling terminal is an integrated financial self-service facility with multiple functions such as bill recycling, deposit, withdrawal, temporary storage, sorting, counting, identification of counterfeit banknote, record of banknote serial number, continuous banknote input, daily bill keeping and inquiry, and it can realize recycling of domestic circulating banknotes of various denomination.

The related art provides a bill recycling terminal. The bill recycling terminal includes an input device, an output device, a temporary storage device, a recycling box, a recovering box and a conveying passage connecting the above parts. When the bill recycling terminal is working, the banknote is conveyed in the conveying passage from one of the above parts to another. When a banknote is conveyed in the conveying passage, it cannot reach a set position within a set time due to a fault of the banknote (such as soft banknote or banknote of abnormal size) or the passage (such as dust on the passage surface or slip of the driving roller in the passage), i.e. a banknote jam occurs. If the bill recycling terminal continues working when a banknote is jammed, other banknotes may also be jammed at the position where the banknote jams, resulting in damage to the banknotes.

### SUMMARY

The following summarizes the subject detailed in this disclosure. This summary is not intended to limit the scope of the claimed disclosure.

This disclosure provides a banknote jam troubleshooting method to timely discharge the banknote in the passage in case of banknote jam, to prevent further banknote jam.

This disclosure provides a bill recycling terminal to timely discharge the banknote in the passage in case of banknote jam, to prevent further banknote jam.

The embodiments of this disclosure provide a banknote jam troubleshooting method for bill recycling terminal; the bill recycling terminal includes an input device, an output device, a temporary storage device, a recycling box, a recovering box and a conveying passage connecting the input device, the output device, the temporary storage device, the recycling box and the recovering box; the conveying passage includes multiple conveying sub-channels; each conveying sub-channel is provided with an independently controlled conveying mechanism; the conveying mechanism is provided with at least one conveying assembly. The banknote jam troubleshooting method includes, determining a troubleshooting path and a discharge device in case of banknote jam in the conveying passage, where the discharge device is any one among the input device, the output device, the temporary storage device, the recycling box or the recovering box, and the troubleshooting path is a path in the conveying passage for connecting the position of banknote jam to the discharge device; determining the multiple conveying sub-channels on the troubleshooting path; orderly discharging the banknotes in the multiple conveying sub-channels on the troubleshooting path from the sub-channel nearest to the discharge device to the sub-channel furthest.

The embodiments of this disclosure provide a bill recycling terminal including an input device, an output device, a temporary storage device, a recycling box, a recovering box and a conveying passage connecting the input device, the output device, the temporary storage device, the recycling box and the recovering box; the conveying passage includes multiple conveying sub-channels; each conveying sub-channel is provided with an independently controlled conveying mechanism; the conveying mechanism is provided with at least one conveying assembly. The bill recycling terminal further includes a detecting device and a control device; the detecting device is arranged in the conveying passage to detect whether banknote jam occurs in the conveying passage and to detect the position of banknote jam if it occurs; the control device is in electric connection with the detecting device and the conveying mechanism; the control device includes a first determining module, a second determining module and an actuator module; the first determining module is configured to determine the troubleshooting path and the discharge device in case of banknote jam in the conveying passage, where the discharge device is any one among the input device, the output device, the temporary storage device, the recycling box or the recovering box, and the troubleshooting path is a path in the conveying passage for connecting the position of banknote jam to the discharge device; the second determining module is configured to determine the multiple conveying sub-channels on the troubleshooting path; the actuator module is configured to orderly discharge the banknotes in the multiple conveying sub-channels on the troubleshooting path from the sub-channel nearest to the discharge device to the sub-channel furthest.

The reader can understand other aspects after reading and understanding the drawings and the detailed description.

### BRIEF DESCRIPTION OF DRAWINGS

The drawings necessary for the embodiments will be briefly introduced below to give a clearer description of the embodiments of this disclosure. It should be noted that, the drawings below only illustrate some of the embodiments of this disclosure, and thus they shall not be considered as a limit to the scope. Other drawings can be acquired based on the said drawings by general technicians in the field without making creative effort.

FIG. 1 is a structural view of a bill recycling terminal with a first troubleshooting path indicated according to an embodiment of this disclosure;

FIG. 2 is a functional block diagram of a control device according to an embodiment of this disclosure;

FIG. 3 is a functional block diagram of a first determining module of a control device according to an embodiment of this disclosure;

FIG. 4 is a structural view of a bill recycling terminal with a second troubleshooting path indicated according to an embodiment of this disclosure;

FIG. 5 is a flow chart of a banknote jam troubleshooting method according to an embodiment of this disclosure;

FIG. 6 is a flow chart of a method for determining a troubleshooting path and a banknote discharge device in a banknote jam troubleshooting method according to an embodiment of this disclosure.

In the figure: 100—bill recycling terminal; 101—conveying passage; 103—recycling box; 104—first conveying sub-channel; 105—conveying assembly; 106—second conveying sub-channel; 107—first conveying assembly; 109—second conveying assembly; 111—third conveying assembly; 113—fourth conveying assembly; 115—fifth conveying assembly; 117—input device; 119—output device; 121—temporary storage device; 122—identification device; 123—control device; 125—recovering device; 129—first determining module; 131—second determining module; 133—actuator module; 135—acquiring unit; 137—determining unit; 139—third conveying sub-channel; 141—fourth conveying sub-channel; 143—fifth conveying sub-channel; 145—sixth conveying sub-channel.

### DETAILED DESCRIPTION

The technical solutions in the embodiments of this disclosure will be clearly and completely described as follows by combining with the drawings herein. The said embodiments are only some of rather than all of the embodiments of this disclosure.

It should be noted that, similar numbers and letters refer to similar items in the following drawings. Therefore, once an item is defined in one drawing, such item will not be redefined or

In the descriptions of the embodiments of this disclosure, it should be noted that, the words “first”, “second”, “third”, “fourth” and “fifth” are only used for distinguishing the descriptions, and cannot be understood as indicating or implying relative importance.

### Embodiment 1

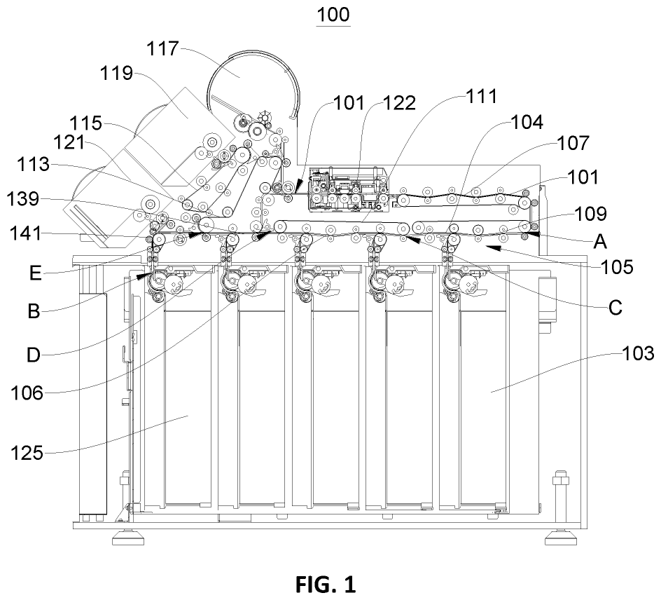

FIG. 1 is a structural view of a bill recycling terminal 100 with a first troubleshooting path indicated according to the embodiment. As shown in FIG. 1, the embodiment provides a bill recycling terminal 100 including an input device 117, an output device 119, a temporary storage device 121, a recycling box 103, a recovering box 125 and a conveying passage 101 connecting the input device 117, the output device 119, the temporary storage device 121, the recycling box 103 and the recovering box 125; the conveying passage 101 includes multiple conveying sub-channels; each conveying sub-channel is provided with an independently controlled conveying mechanism; the conveying mechanism includes at least one conveying assembly 105, where the conveying assembly 105 may be driven by a roller or a belt. For example, in the embodiment, the conveying mechanism in the conveying passage 101 includes a first conveying assembly 107, a second conveying assembly 109, a third conveying assembly 111, a fourth conveying assembly 113 and a fifth conveying assembly 115 orderly arranged along the length of the conveying passage 101; each conveying assembly 105 corresponds to a conveying sub-channel; each conveying assembly 105 is driven by a motor; in case that there is a banknote located at the corresponding conveying assembly 105, the banknote may be driven for motion in a preset direction by driving the corresponding conveying assembly 105 for rotation in the preset direction.

The input device 117 is configured to receive the banknotes put in by the user for deposit. An identification device 122 is provided in the conveying passage 101; the identification device 122 is configured to identify the denomination, category and authenticity of banknotes. The output device 119 is configured to receive the unqualified banknotes identified by the identification device 122, or configured to receive the banknotes from the recycling box 103 for withdrawal. The temporary storage device 121 is configured to temporarily store the qualified banknotes identified by the identification device 122. The bill recycling terminal 100 can provide multiple services such as deposit, withdrawal, sorting and counting, where the banknotes are conveyed in different paths as the bill recycling terminal 100 provides different services.

For example, in case of deposit, the user puts the banknotes into the inlet of the input device 117; the banknotes are fed into the conveying passage 101 one by one by a banknote collecting and separating device arranged at the inlet, and then conveyed to the identification device 122 by the conveying mechanism through the conveying passage 101; the identification device 122 identifies the banknotes; the qualified banknotes identified by the identification device 122 are conveyed to the temporary storage device 121 by the conveying mechanism through the conveying passage 101 for temporary storage; the unqualified banknotes identified by the identification device 122 are conveyed to the outlet of the output device 119 by the conveying mechanism through the conveying passage 101 for the user. If the deposit is confirmed, the banknotes temporarily stored in the temporary storage device 121 will be conveyed to the identification device 122 by the conveying mechanism through the conveying passage 101 for identification; the banknotes not suitable for circulation, such as outdated banknote or banknote with defective surface, will be conveyed to the recovering box 125 by the conveying mechanism through the conveying passage 101 for storage; the banknotes suitable for circulation will be conveyed to the recycling box 103 by the conveying mechanism through the conveying passage 101 for storage; if the deposit is canceled, the gate of the temporary storage device 121 will be opened, so that the user can take out the banknotes temporarily stored in the temporary storage device 121. Therefore, in case of deposit, prior to confirmation or canceling, the banknotes are conveyed from the input device 117 to the temporary storage device 121 through the identification device 122, or conveyed from the input device 117 to the output device 119 through the identification device 122, or conveyed from the input device 117 to the temporary storage device 121; after confirmation or canceling, the banknotes are conveyed from the temporary storage device 121 to the recovering box 125, or conveyed from the temporary storage device 121 to the recycling box 103. Apparently, in other embodiments of the embodiment, the bill recycling terminal 100 may also provide deposit service in other modes. For example, the qualified banknotes identified by the identification device 122 may be directly conveyed into the recycling box 103 or the recovering box 125. The modes will not be detailed in the embodiment.

For example, in case of withdrawal, the user enters the amount of withdrawal, the banknotes in the recycling box 103 are fed into the conveying passage 101 one by one by the banknote collecting and separating device arranged at the slot of the recycling box 103, and then conveyed to the identification device 122 by the conveying mechanism through the conveying passage 101; after being counted by the identification device 122, the banknotes will be conveyed to the output device 119 by the conveying mechanism; the gate of the output device 119 is opened after all the banknotes of the amount entered by the user reach the output device 119, so that the user can take out the banknotes from the outlet of the output device 119. Therefore, in case of withdrawal, the banknotes are conveyed from the recycling box 103 to the output device 119 through the identification device 122.

Of course, in other embodiments of the embodiment, the bill recycling terminal 100 may also provide other services such as banknote sorting and checking. The services will not be detailed in the embodiment.

In the embodiment, the bill recycling terminal 100 further includes a detecting device (not shown in the figure) and a control device (not shown in FIG. 1). The detecting device is configured to detect whether banknote jam occurs in the conveying passage 101 and to detect the position of banknote jam if it occurs in the conveying passage 101; the control device is in electric connection with the detecting device and the conveying mechanism, respectively. For example, in the embodiment, the detecting device is arranged in the conveying passage 101; the detecting device may include multiple sets of sensors arranged at an interval, and it may also be other detecting assemblies. In the embodiment, the detecting device includes multiple sets of sensors arranged at an interval along the length of the conveying passage 101 (that is along the direction consistent with or opposite to the banknote conveying direction); each set of sensors includes multiple sensors arranged at an interval along the width of the conveying passage 101 (that is along the direction vertical to the banknote conveying direction). In cases that there are banknotes and there is no banknote at the detecting positions of the sensors, the sensors output different signals; the control device 123 determines whether banknote jam occurs in the conveying passage 101 by determining whether the duration of the banknotes at the detecting position of each sensor exceed a set time; in case of banknote jam in the conveying passage 101, the control device determines the position of banknote jam based on the position of the sensor with continuous banknotes.

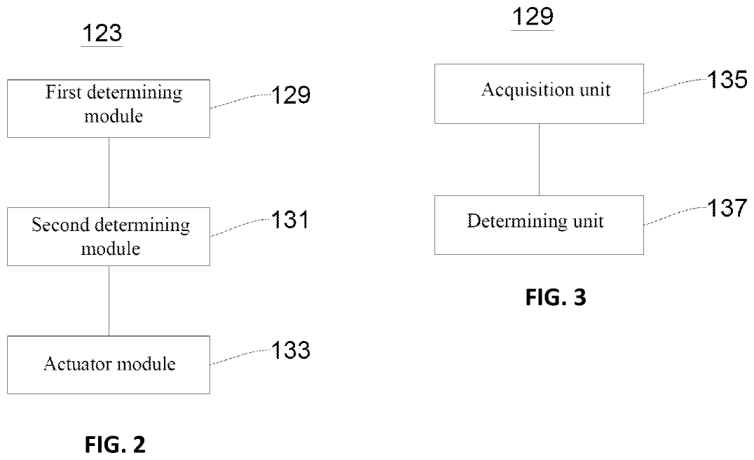

FIG. 2 is a functional block diagram of the control device 123 according to the embodiment. As shown in FIG. 2, in the embodiment, the control device 123 includes a first determining module 129, a second determining module 131 and an actuator module 133. The first determining module 129 is configured to determine the troubleshooting path and the discharge device in case of banknote jam in the conveying passage 101 detected by the detecting device. The discharge device is any one among the input device 117, the output device 119, the temporary storage device 121, the recycling box 103 or the recovering box 125, and the troubleshooting path is a path in the conveying passage 101 for connecting the position of banknote jam to the discharge device. The second determining module 131 is configured to determine the multiple conveying sub-channels on the troubleshooting path. The actuator module 133 is configured to orderly discharge the banknotes in the multiple conveying sub-channels on the troubleshooting path from the sub-channel nearest to the discharge device to the sub-channel furthest. The banknotes in the conveying sub-channels near the discharge device are preferentially discharged by determining the troubleshooting path and the discharge device and then determining the multiple conveying sub-channels on the troubleshooting path; the banknotes in the passage may be timely discharged in case of banknote jam, to prevent further banknote jam.

For example, as shown in FIG. 1, in case that banknote jam occurs at point A in the conveying passage 101, and the first determining module 129 detects the banknote jam in the conveying passage 101 and determines the position of banknote jam is A, if the preset discharge device is the recovering box 125, the first determining module 129 will determine the recovering box 125 as the discharge device, and the troubleshooting path will be a path connecting point A in the conveying passage 101 to point B at the inlet of the recovering box 125. The second determining module 131 is configured to determine the multiple conveying sub-channels from point A to point B on the troubleshooting path; it is assumed that four conveying sub-channels are respectively determined as the first conveying sub-channel 104, the second conveying sub-channel 106, the third conveying sub-channel 139 and the fourth conveying sub-channel 141; the first conveying sub-channel 104 is from point A to point C; the second conveying sub-channel 106 is from point C to point D; the third conveying sub-channel 139 is from point D to point E; the fourth conveying sub-channel 141 is from point E to point B. The actuator module 133 is configured to orderly discharge the banknotes in the fourth conveying sub-channel 141, the third conveying sub-channel 139, the second conveying sub-channel 106 and the first conveying sub-channel 104 from the sub-channel nearest to the recovering device 125 to the sub-channel furthest, thus to prevent further banknote jam. When the banknotes in a conveying sub-channel are discharged, the conveying assembly 105 in the conveying sub-channel and in the conveying sub-channel on the downstream side of the said conveying sub-channel in the banknote conveying direction for discharge rotates in a preset direction, and the conveying assembly 105 in the conveying sub-channel on the upstream side of the said conveying sub-channel do not rotate, so that the banknotes in the multiple conveying sub-channels may be discharged one sub-channel by one sub-channel. The conveying assembly 105 in each conveying sub-channel rotates in the preset direction to convey the banknotes in the sub-channel towards the discharge device. For example, in the embodiment, when the banknotes in the fourth conveying sub-channel 141 are discharged, the conveying assembly 105 in the fourth conveying sub-channel 141 rotates in a preset direction, and the conveying assemblies 105 in the first conveying sub-channel 104, the second conveying sub-channel 106 and the third conveying sub-channel 139 do not rotate; when the banknotes in the third conveying sub-channel 139 are discharged, the conveying assemblies 105 in the fourth conveying sub-channel 141 and the third conveying sub-channel 139 rotate in a preset direction, and the conveying assemblies 105 in the first conveying sub-channel 104 and the second conveying sub-channel 106 do not rotate.

It should be noted that, in other embodiments of this disclosure, the discharge device may also be preset as any one among the input device 117, the output device 119, the temporary device 121 and the recycling box 103. It will not be detailed in the embodiment.

FIG. 3 is a functional block diagram of the first determining module 129 of the control device 123 according to the embodiment. As shown in FIG. 3, the first determining module 129 includes an acquiring unit 135 and a determining unit 137. The acquiring unit 135 is configured to acquire the service type of the bill recycling terminal 100 and the banknote conveying path corresponding to the service type in case of banknote jam. The determining unit 137 is configured to determine the troubleshooting path and the discharge device according to the service type and the corresponding conveying path.

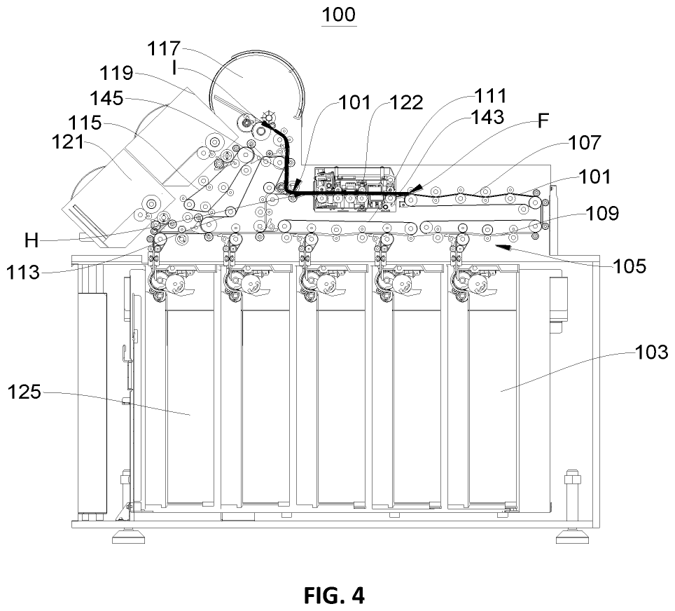

For example, FIG. 4 is a structural view of the bill recycling terminal 100 with a second troubleshooting path indicated according to the embodiment. As shown in FIG. 4, in case of deposit operation, the user put the banknotes in the inlet of the input device 117; the banknotes are conveyed to the identification device 122 through the conveying passage 101; it is assumed that banknote jam occurs at point F in the conveying passage 101 before the user confirms or cancels the deposit and after the banknotes pass through the identification device 122. The acquiring unit 135 acquires that the present service type is deposit; as the service type is deposit, and the banknotes are conveyed from the input device 117 to the temporary storage device 121 through the identification device 122 before the deposit is confirmed or canceled, the determining unit 137 determines the troubleshooting path is from point F where the banknote jams to point I at the inlet of the input device 117 and determines the input device 117 as the discharge device according to the service type (namely deposit) of the bill recycling terminal 100 and the conveying path (namely the path from the input device 117 to the temporary storage device 121 through the identification device 122) when the banknote jam occurs. Next, it is assumed that the second determining module 131 determines the conveying sub-channels corresponding to the troubleshooting path from point F of banknote jam to the input device 117 are a fifth conveying sub-channel 143 and a sixth conveying sub-channel 145; the fifth conveying sub-channel 143 is from point F to point H, and the sixth conveying sub-channel 145 is from point H to point I at the inlet of the input device 117. Then the actuator module 133 orderly starts the sixth conveying sub-channel 145 and the fifth conveying sub-channel 143 from the one nearest to the discharge device (namely the input device 117) to the one furthest, so that the banknotes near the discharge device may be preferentially discharged and thus the banknotes in the conveying sub-channel may be timely discharged in case of banknote jam, to prevent further banknote jam.

It should be noted that, in one example, the discharge device may be determined as a device being able to output banknotes, such as the output device 119 or the recovering box 125, to reduce the discharge time and improve the discharge efficiency. The output device 119 may discharge the banknotes through the outlet of the output device 119. The recovering box 125 may collect the banknotes and store them in the box for the staff to take them out.

For example, in the embodiment, the actuator module 133 includes a starting unit. The starting unit is configured to orderly start the conveying assemblies 105 in the multiple conveying sub-channels for rotation in a preset direction according to a preset condition, where the conveying assembly 105 in each conveying sub-channel rotates in the preset direction to convey the banknotes in the conveying sub-channel towards the discharge device.

For example, in the embodiment, the starting unit is configured to orderly start the conveying assemblies 105 in the multiple conveying sub-channels on the troubleshooting path at a preset time interval for rotation in a preset direction. For example, the starting unit is configured to orderly start the conveying assemblies 105 of the second conveying sub-channel 106 and the first conveying sub-channel 104 at a preset time interval for rotation in a preset direction. If the preset time is 10 s, then the starting unit is configured to orderly start the corresponding conveying assemblies 105 of the second conveying sub-channel 106 and the first conveying sub-channel 104 at a time interval of 10 s, to orderly discharge the banknotes jammed in the second conveying sub-channel 106 and the first conveying sub-channel 104.

Of course, it should be noted that, in other embodiments of this disclosure, the starting unit may also be configured to start the conveying assembly 105 in a former conveying sub-channel for rotation in a preset direction, and to start the conveying assembly 105 in a latter conveying sub-channel for rotation in the preset direction in case that no banknote is detected in the former conveying sub-channel, so that the banknotes jammed may be orderly discharged. It should be noted that, the former conveying sub-channel and the latter conveying sub-channel are two adjacent conveying sub-channels on the troubleshooting path, and the former conveying sub-channel is on the downstream side of the latter conveying sub-channel in the banknote conveying direction when the banknotes are discharged. For example, the former conveying sub-channel is the second conveying sub-channel 106 as shown in FIG. 1, and the latter conveying sub-channel is the first conveying sub-channel 104 as shown in FIG. 1; the former conveying sub-channel is the fourth conveying sub-channel 141 as shown in FIG. 1, and the latter conveying sub-channel is the third conveying sub-channel 139 as shown in FIG. 1; the former conveying sub-channel is the sixth conveying sub-channel 145 as shown in FIG. 4, and the latter conveying sub-channel is the fifth conveying sub-channel 143 as shown in FIG. 4.

### Embodiment 2

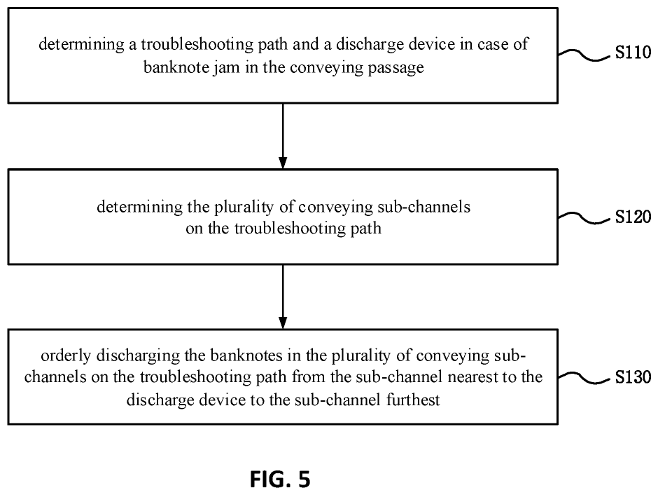

FIG. 5 is a flow chart of a banknote jam troubleshooting method according to the embodiment. As shown in FIG. 5, the embodiment provides a banknote jam troubleshooting method for a bill recycling terminal 100; the bill recycling terminal 100 includes an input device 117, an output device 119, a temporary storage device 121, a recycling box 103, a recovering box 125 and a conveying passage 101 connecting the input device 117, the output device 119, the temporary storage device 121, the recycling box 103 and the recovering box 125; the conveying passage 101 includes multiple conveying sub-channels; each conveying sub-channel is provided with an independently controlled conveying mechanism; the conveying mechanism includes at least one conveying assembly 105. This banknote jam troubleshooting method includes steps S110-S130.

In step S110, a troubleshooting path and a discharge device are determined in case of banknote jam in the conveying channel 101, where the discharge device is any one among the input device 117, the output device 119, the temporary storage device 121, the recycling box 103 or the recovering box 125, and the troubleshooting path is a path in the conveying passage 101 for connecting the position of banknote jam to the discharge device.

For example, for the bill recycling terminal 100 according to Embodiment 1, the detecting device of the bill recycling terminal 100 detects banknote jam in the conveying passage 101 and detects the position of banknote jam, the first determining module 129 will determine the troubleshooting path and the discharge device.

In one example, the discharge device may be the output device 119 or the recovering box 125.

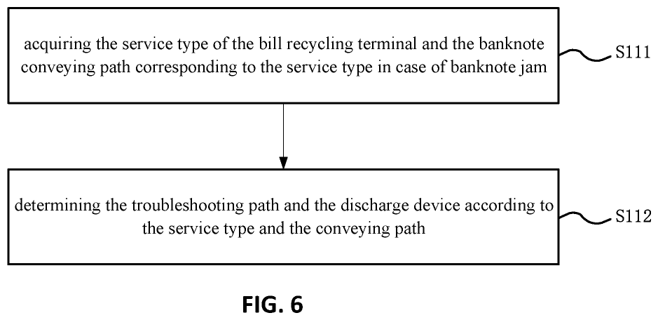

FIG. 6 is a flow chart of a method for determining a troubleshooting path and a banknote discharge device in the banknote jam troubleshooting method according to the embodiment. As shown in FIG. 6, in the embodiment, the determining of the troubleshooting path and the discharge device includes step S111 and step S112.

In step S111, the service type of the bill recycling terminal 100 and the banknote conveying path corresponding to the service type in case of banknote jam are acquired.

In step S112, the troubleshooting path and the discharge device are determined according to the service type and the conveying path.

For the bill recycling terminal 100 according to Embodiment 1, the service type of the bill recycling terminal 100 and the banknote conveying path corresponding to the service type may be acquired by the acquiring unit 135 in case of banknote jam. Meanwhile, the troubleshooting path and the discharge device may be determined by the determining unit 137 according to the service type and the corresponding conveying path.

In step S120, the multiple conveying sub-channels on the troubleshooting path are determined.

For example, for the bill recycling terminal 100 according to Embodiment 1, the multiple conveying sub-channels on the troubleshooting path may be determined by the second determining module 131 of the control device 123 of the bill recycling terminal 100.

In step S130, the banknotes in the multiple conveying sub-channels on the troubleshooting path are orderly discharged from the sub-channel nearest to the discharge device to the sub-channel furthest.

The embodiments of this disclosure provide a banknote jam troubleshooting method, where the banknotes in the conveying sub-channels near the discharge device are preferentially discharged by determining the troubleshooting path and the discharge device and then determining the multiple conveying sub-channels on the troubleshooting path; the banknotes in the channel may be timely discharged in case of banknote jam, to prevent further banknote jam.

For example, for the bill recycling terminal 100 according to Embodiment 1, the banknotes in the multiple conveying sub-channels on the troubleshooting path may be orderly discharged by the actuator module 133 from the sub-channel nearest to the discharge device to the sub-channel furthest.

In the embodiment, the orderly discharging of the banknotes in the multiple conveying sub-channels on the troubleshooting path includes: orderly starting the conveying assemblies 105 in the multiple conveying sub-channels for rotation in a preset direction according to a preset condition. The conveying assembly 105 in each conveying sub-channel rotates in the preset direction to convey the banknotes in the sub-channel towards the discharge device.

For example, for the bill recycling terminal 100 according to Embodiment 1, the starting unit is configured to orderly start the conveying assemblies 105 in the multiple conveying sub-channels from the sub-channel nearest to the discharge device to the sub-channel furthest for rotation in a preset direction according to a preset condition, so that the banknotes near the discharge device can be preferentially discharged, to prevent the banknotes away from the discharge device from being further jammed with the banknotes near the discharge device when moving towards the discharge device.

For example, in the embodiment, the conveying assemblies 105 in the multiple conveying sub-channels on the troubleshooting path are orderly started for rotation in a preset direction according to a preset condition. Specifically, the conveying assemblies 105 in the multiple conveying sub-channels are orderly started at a preset time interval. Of course, it should be noted that, in other embodiments of this disclosure, the way that the conveying assemblies 105 in the multiple conveying sub-channels on the troubleshooting path can be orderly started for rotation in a preset direction according to a preset condition can also refer to that the conveying assembly 105 in the former conveying sub-channel is started for rotation in a preset direction, and the conveying assembly 105 in the latter conveying sub-channel is started for rotation in the preset direction in case that no banknote is detected in the former conveying sub-channel, so that the banknotes jammed can be orderly discharged. The former conveying sub-channel and the latter conveying sub-channel are two adjacent conveying sub-channels on the troubleshooting path in the banknote conveying direction when the banknotes are discharged; the former conveying sub-channel is on the downstream side of the latter conveying sub-channel.

1. A banknote jam troubleshooting method for a bill recycling terminal; the bill recycling terminal comprising an input device, an output device, a temporary storage device, a recycling box, a recovering box and a conveying passage connecting the input device, the output device, the temporary storage device, the recycling box and the recovering box; the conveying passage comprising a plurality of conveying sub-channels; each conveying sub-channel being provided with an independently controlled conveying mechanism; the conveying mechanism comprising at least one conveying assembly; and the banknote jam troubleshooting method comprising:
determining a troubleshooting path and a discharge device in case of banknote jam in the conveying passage, wherein the discharge device is any one among the input device, the output device, the temporary storage device, the recycling box or the recovering box, and the troubleshooting path is a path in the conveying passage for connecting the position of banknote jam to the discharge device;
determining the plurality of conveying sub-channels on the troubleshooting path; and orderly discharging the banknotes in the plurality of conveying sub-channels on the troubleshooting path from the sub-channel nearest to the discharge device to the sub-channel furthest.

2. The banknote jam troubleshooting method according to claim 1, wherein the determining of the troubleshooting path and the discharge device comprises:
acquiring the service type of the bill recycling terminal and the banknote conveying path corresponding to the service type in case of banknote jam; and
determining the troubleshooting path and the discharge device according to the service type and the conveying path.

3. The banknote jam troubleshooting method according to claim 1, wherein the orderly discharging of the banknotes in the plurality of conveying sub-channels on the troubleshooting path comprises:
orderly starting the conveying assemblies of the plurality of conveying sub-channels on the troubleshooting path for rotation in a preset direction according to a preset condition;
wherein the conveying assembly in each conveying sub-channel rotates in the preset direction to convey the banknotes in the sub-channel towards the discharge device.

4. The banknote jam troubleshooting method according to claim 3, wherein the orderly starting of the conveying assemblies of the plurality of conveying sub-channels on the troubleshooting path for rotation in a preset direction according to a preset condition comprises:
orderly starting the conveying assemblies of the plurality of conveying sub-channels on the troubleshooting path according to a preset time interval for rotation in the preset direction; or
starting the conveying assembly in a former conveying sub-channel for rotation in the preset direction; starting the conveying assembly in a latter conveying sub-channel for rotation in the preset direction when no banknote is detected in the former conveying sub-channel;
wherein the former conveying sub-channel and the latter conveying sub-channel are two adjacent conveying sub-channels on the troubleshooting path in the banknote conveying direction when the banknotes are discharged; the former conveying sub-channel is on the downstream side of the latter conveying sub-channel.

5. The banknote jam troubleshooting method according to claim 1, wherein the discharge device is the output device or the recycling box.

6. A bill recycling terminal, comprising an input device, an output device, a temporary storage device, a recycling box, a recovering box and a conveying channel connecting the input device, the output device, the temporary storage device, the recycling box and the recovering box; wherein the conveying passage comprises a plurality of conveying sub-channels; each conveying sub-channel is provided with an independently controlled conveying mechanism; the conveying mechanism comprises at least one conveying assembly; the bill recycling terminal further comprises a detecting device and a control device;
the detecting device is arranged in the conveying passage to detect whether banknote jam occurs in the conveying passage and to detect the position of banknote jam if it occurs;
the control device is in electric connection with the detecting device and the conveying mechanism, respectively; the control device comprises a first determining module, a second determining module and an actuator module;
the first determining module is configured to determine the troubleshooting path and the discharge device in the conveying passage in case of banknote jam, wherein the discharge device is any one among the input device, the output device, the temporary storage device, the recycling box or the recovering box, and the troubleshooting path is a path in the conveying passage for connecting the position of banknote jam to the discharge device;
the second determining module is configured to determine the plurality of conveying sub-channels on the troubleshooting path; and
the actuator module is configured to orderly discharge the banknotes in the plurality of conveying sub-channels on the troubleshooting path from the sub-channel nearest to the discharge device to the sub-channel furthest.

7. The bill recycling terminal according to claim 6, wherein the first determining module comprises:
an acquiring unit configured to acquire the service type of the bill recycling terminal and the banknote conveying path corresponding to the service type in case of banknote jam; and
a determining unit configured to determine the troubleshooting path and the discharge device according to the service type and the conveying path.

8. The bill recycling terminal according to claim 7, wherein the actuator module comprises:
a starting unit configured to orderly start the conveying assemblies of the plurality of conveying sub-channels on the troubleshooting path for rotation in a preset direction according to a preset condition;
wherein the conveying assembly in each conveying sub-channel rotates in the preset direction to convey the banknotes in the sub-channel towards the discharge device.

9. The bill recycling terminal according to claim 8, wherein the starting unit is configured to:
orderly start the conveying assemblies of the plurality of conveying sub-channels on the troubleshooting path according to a preset time interval for rotation in the preset direction; or
start the conveying assembly in a former conveying sub-channel for rotation in the preset direction; start the conveying assembly in a latter conveying sub-channel for rotation in the preset direction when no banknote is detected in the former conveying sub-channel;
wherein the former conveying sub-channel and the latter conveying sub-channel are two adjacent conveying sub-channels on the troubleshooting path in the banknote conveying direction when the banknotes are discharged; the former conveying sub-channel is on the downstream side of the latter conveying sub-channel.

10. The bill recycling terminal according to claim 6, wherein the discharge device is the output device or the recycling box.

11. The banknote jam troubleshooting method according to claim 2, wherein the discharge device is the output device or the recycling box.

12. The banknote jam troubleshooting method according to claim 3, wherein the discharge device is the output device or the recycling box.

13. The banknote jam troubleshooting method according to claim 4, wherein the discharge device is the output device or the recycling box.

14. The bill recycling terminal according to claim 7, wherein the discharge device is the output device or the recycling box.

15. The bill recycling terminal according to claim 8, wherein the discharge device is the output device or the recycling box.

16. The bill recycling terminal according to claim 9, wherein the discharge device is the output device or the recycling box.
